(19) United States
(12) Patent Application Publication
(10) Pub. No.: US 2018/0005308 A1
(43) Pub. Date: Jan. 4, 2018

(54) CONSUMABLE MANAGEMENT SERVER AND CONSUMABLE MANAGEMENT SYSTEM

(71) Applicant: SEIKO EPSON CORPORATION, Tokyo (JP)

(72) Inventors: Go ISHIDA, Tatsuno-machi (JP); Yoshiaki IMAI, Okaya-shi (JP)

(21) Appl. No.: 15/617,539

(22) Filed: Jun. 8, 2017

(30) Foreign Application Priority Data
Jun. 29, 2016 (JP) 2016-129109

(51) Int. Cl. G06Q 30/06; G06Q 10/08

(52) U.S. Cl. CPC G06Q 30/0635; G06Q 10/083

(57) ABSTRACT

A consumable management server connectable to a network includes a management section that manages identification information of a device using a consumable and supplier information indicating a supplier of the device in association with each other, a consumable information acquisition section that acquires consumable information on the consumable of the device through the network, and a delivery request processing section that transmits a delivery request for the consumable to the supplier through the network based on the supplier information associated with the identification information of the device in a case where the consumable is determined to be in a state of requiring replacement based on the consumable information.

### CROSS-REFERENCE TO RELATED APPLICATIONS

The present application claims priority to Japanese Patent Application No. 2016-129109, filed Jun. 29, 2016, which is hereby incorporated by reference in its entirety.

### BACKGROUND

### 1. Technical Field

The present invention relates to a server and a system for managing consumables that are used by a device.

### 2. Related Art

A user of a printer needs to replace consumables such as ink as necessary. To support such a user, known application software monitors the amount of ink remaining in a printer and, when the amount of remaining ink becomes small, encourages the user to purchase ink.

A known print apparatus consumable purchase system includes a controller operable to display a status screen for representing the consumption degree of a consumable used in a print apparatus on a display, and to display, in the status screen, a delivery purchase button for requesting delivery purchase of the consumable (see JP-A-2002-123384).

### SUMMARY

In the technique described above, however, it is not easy for a user to obtain consumables of a product (device such as a printer) from a supplier of the product.

An advantage of some aspects of the invention is to provide a consumable management server and a consumable management system that enable a consumable that needs replacement to be easily available from a supplier of the device.

In an aspect of the present invention, a server (consumable management server) connectable to a network includes: a management section that manages identification information of a device using a consumable and supplier information indicating a supplier of the device in association with each other; a consumable information acquisition section that acquires consumable information on the consumable of the device through the network; and a delivery request processing section that transmits a delivery request for the consumable to the supplier through the network based on the supplier information associated with the identification information of the device in a case where the consumable is determined to be in a state of requiring replacement based on the consumable information.

With this configuration, in a case where a consumable of a device is in the state of requiring replacement, the consumable management server transmits a delivery request for a consumable to a supplier through the network, based on supplier information associated with identification information of the device. Accordingly, a user of the device can obtain (purchase) a necessary consumable without purchasing the consumable by himself/herself. In addition, since a consumable is delivered from a supplier from which the user purchased the device, profit of the supplier can be assured.

In the aspect of the present invention, the delivery request processing section may determine, based on the consumable information, whether replacement of the consumable is performed or not after transmission of a previous delivery request and whether a consumption degree of a current consumable exceeds a predetermined level or not and if replacement of the consumable is performed after transmission of the previous delivery request and the consumption degree of the current consumable exceeds the predetermined level, the delivery request processing section may determine that the consumable is in the state of requiring replacement.

With this configuration, it is possible to avoid, with respect to a device requiring replacement of consumables, unintentional transmission of another delivery request for the consumable after a delivery request for the consumable and before replacement of the consumable (duplicate order of the consumable).

In the aspect of the present invention, if one of a plurality of consumables mounted on the device is in a state of requiring replacement, the delivery request processing section may transmit, to the supplier, the delivery request for the consumable in the state of requiring replacement and a consumable except the consumable in the state of requiring replacement.

With this configuration, the load of a delivery side can be reduced by executing the delivery request for not only a consumable requiring replacement but also another consumable that does not currently need replacement but will need replacement in near future.

A technical idea of the invention can be implemented by another system except a server (consumable management server).

For example, it is possible to understand, as an aspect of the invention, a consumable management system including: a device using a consumable; and a consumable management server including a management section that manages identification information of the device and supplier information indicating a supplier of the device in association with each other, and a delivery request processing section that acquires consumable information on the consumable of the device through a network and, in a case where the consumable is determined to be in a state of requiring replacement based on the consumable information, transmits a delivery request for the consumable to the supplier through the network based on the supplier information associated with the identification information of the device.

In the aspect of the present invention, the consumable management system may further include a supplier server that belongs to the supplier, the delivery request processing section may transmit the delivery request together with the identification information of the device for which the consumable is in the state of requiring replacement, to the supplier server through the network, and the supplier server may include a delivery destination management section that manages identification information of a purchased device and delivery destination information indicating a delivery destination of the consumable in association with each other and a delivery processing section that executes a delivery process of the consumable based on the delivery destination information associated with the identification information received from the consumable management server together with the delivery request in the delivery destination management section.

With this configuration, the supplier server belongs to the supplier and the supplier server receives the delivery request from the consumable management server so that a consumable is delivered from the supplier to a delivery destination previously known by the supplier (supplier server).

A method corresponding to a process executed by the server or system described above, a program causing a computer (server) to execute the method, and a computer-readable recording medium that stores the program may be aspects of the invention.

### BRIEF DESCRIPTION OF THE DRAWINGS

The invention will be described with reference to the accompanying drawings, wherein like numbers reference like elements.

FIG. 1 is a simplified view of a system according to a first embodiment.

FIG. 2 is a view illustrating a relationship among a store-side terminal, a sales management server, and a consumable management server.

FIG. 3 is a view illustrating, for example, a relationship between a user terminal and a consumable management server.

FIG. 4 is a flowchart describing a register confirmation process.

FIG. 5 is a view illustrating a relationship among a consumable management server, a sales management server, and a delivery-side terminal.

FIG. 6 is a flowchart describing a consumable order process.

FIG. 7 is a simplified view of a system according to a second embodiment.

### DESCRIPTION OF EXEMPLARY EMBODIMENTS

Embodiments of the present invention will be described hereinafter with reference to the drawings. The drawings are merely example illustrations of the embodiments.

### 1. First Embodiment

### Overview of System

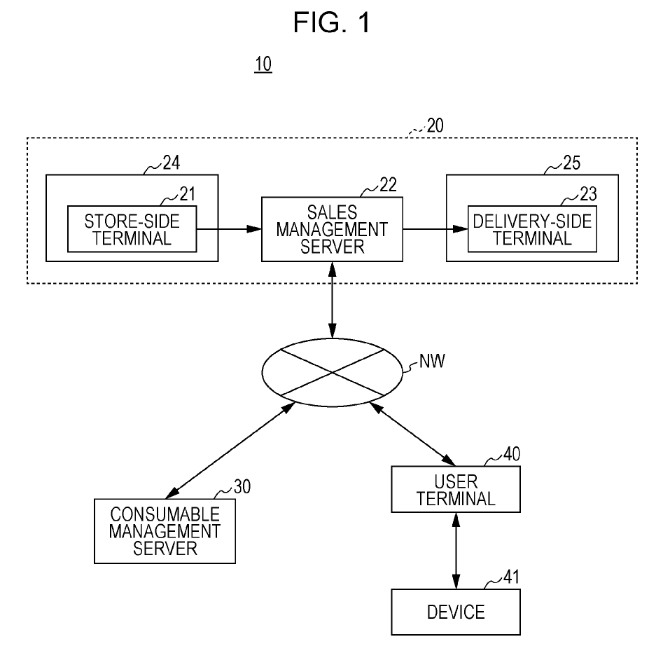

FIG. 1 is a simplified view of a system 10 according to a first embodiment. The system 10 includes, for example, a sales management server 22, a consumable management server 30, a user terminal 40, and a device 41. The sales management server 22, the consumable management server 30, and the user terminal 40 are connected to a network NW. The network NW includes the Internet. The network NW may include a local network (LAN) connected to the Internet, for example. The network NW may be a wired network or a wireless network. At least a part of the configuration of the system 10 will be hereinafter referred to as a consumable management system. The sales management server 22 is an example of a supplier server. The sales management server 22 may be referred to as a first server, and the consumable management server 30 may be referred to as a second server, for example.

The user terminal 40 is implemented by, for example, a personal computer (PC), a smartphone, a tablet terminal, a cellular phone, or a terminal having similar performance. The device 41 is a device that uses consumables. The device 41 corresponds to various products using consumables, such as a printer, a multifunctional device (multifunctional printer), or a projector. In the following description, as an example, the device 41 is a printer, and a consumable is an ink cartridge to be used by the printer (device 41).

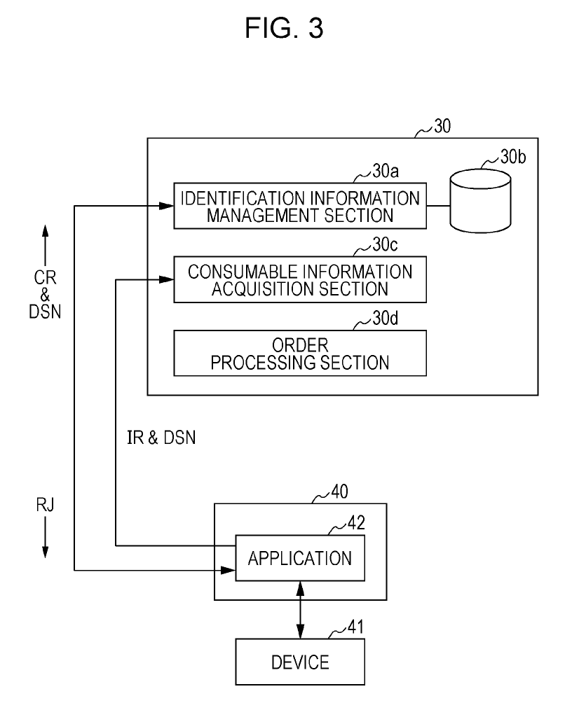

The user terminal 40 is connected to the device 41 by wires or wirelessly so that the user terminal 40 can communicate with the device 41, and controls an operation of the device 41. A driver (printer driver) for controlling the device 41 and an application 42 (see FIG. 3) for implementing a specific function, such as monitoring of the device 41, by the user terminal 40 are installed in advance in the user terminal 40.

The sales management server 22 belongs to a sales channel 20. The sales channel 20 refers to an organization or a group of organizations that sells the device 41 and consumables of the device 41. For example, the sales channel 20 can be an electronics retail store or a distribution group. An entity of the sales channel 20 may be a single company or group or a plurality of related companies or groups sharing profit. Although FIG. 1 illustrates one sales channel 20 as an example, but a plurality of sales channels 20 are present. In the example of FIG. 1, one sales channel 20 includes the store-side terminal 21 and the delivery-side terminal 23 in addition to the sales management server 22.

The store-side terminal 21 is, for example, a terminal provided in a store 24 selling the device 41, and is connected to the sales management server 22 in the sales channel 20. The delivery-side terminal 23 is, for example, a terminal provided in a delivery center 25 that stocks consumables and delivers consumables to the outside when necessary, and is connected to the sales management server 22 in the sales channel 20.

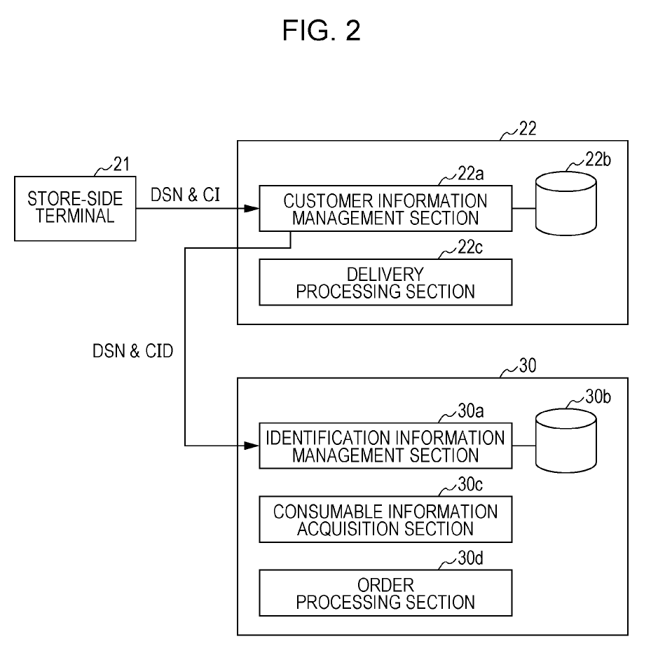

The consumable management server 30 includes, though specifically described later, a management section (identification information management section 30a) that manages identification information of the device 41 that uses consumables and supplier information indicating a supplier of the device 41 in association with each other, and an order processing section 30d (see FIGS. 2, 3, and 5) that transmits to a supplier of the device 41 a request for delivery of a consumable (hereinafter referred to as a delivery request) through a network NW based on supplier information associated with the identification information of the device 41 in a state of requiring consumable replacement. The order processing section 30d corresponds to a delivery request processing section.

A supplier of the device 41 is the sales channel 20 to which the store 24 where a user has purchased the device 41 belongs (i.e., a sales channel 20 that sold the device 41 to the user). When viewing from the consumable management server 30, the sales management server 22 with which the consumable management server 30 communicates through the network NW constitutes a part of the sales channel 20.

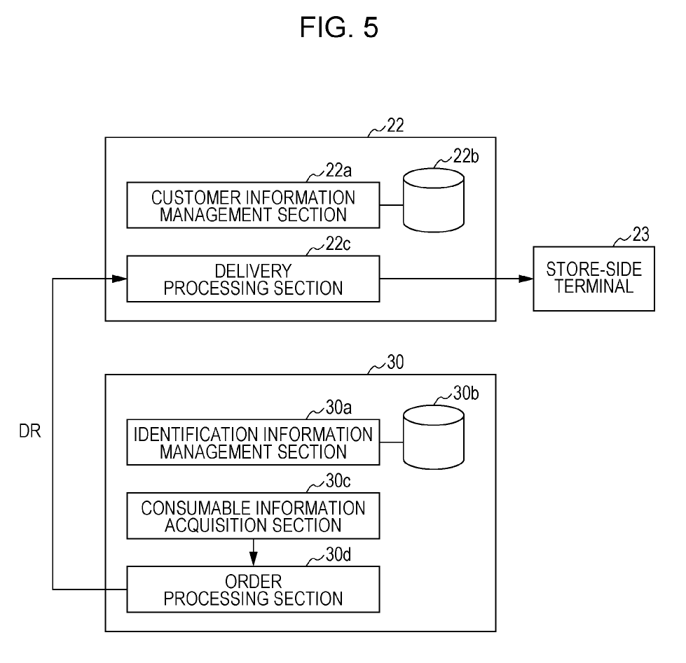

The servers 22 and 30 are servers that provide services to users through the Internet. For example, the servers 22 and 30 are implemented as parts (virtual servers) of a cloud environment that provides a cloud service. Each of the servers 22 and 30 may be referred to as a cloud server. Alternatively, each of the servers 22 and 30 may be a physical server. Sections (22a and 22c, see FIGS. 2 and 5) of the sales management server 22 are implemented by cooperation of hardware and software constituting the sales management server 22, for example. Similarly, sections (30a, 30c, and 30d, see FIGS. 2, 3, and 5) of the consumable management server 30 are implemented by cooperation of hardware and software constituting the consumable management server 30, for example.

For example, the sales management server 22 may provide, as a function thereof, to an internet user a shopping site (virtual store) on the Internet run by the sales channel 20 to which the sales management server 22 belongs. The store 24 may be an actual store or such a virtual store.

Of course, each of the sales management server 22, the consumable management server 30, and the user terminal 40 includes an interface for communicating with the outside through the network NW, and performs communication in accordance with a predetermined communication standard (e.g., TCP/IP or HTTP). In this embodiment, communication among the sales management server 22, the consumable management server 30, and the user terminal 40, communication in the sales channel 20, and communication between the user terminal 40 and the device 41 are not limited to communication based on specific standards.

A service provided to a user of the device 41 mainly by cooperation of the servers 22 and 30 will be hereinafter referred to as a consumable automatic delivery service (hereinafter referred to as a present service). A mechanism of the present service will be described in the following.

### Registration Process Started by Device Purchase

FIG. 2 is a view for describing a relationship among the store-side terminal 21, the sales management server 22, and the consumable management server 30.

Suppose a user purchases a device 41 in a store 24 that belongs to a sales channel 20. In this case, the store 24 accepts an application of the use of the present service from the user who purchased the device 41. Once the user applies for the use of the present service, identification information of the device 41 purchased by the user and personal information (customer information: CI) are transmitted from a store-side terminal 21 to a sales management server 22. The identification information of the device 41 is unique information assigned to each device 41 in advance, and in this example, refers to a serial number (serial number DSN) of each device 41. The customer information CI includes, for example, a user name, an address (delivery destination information), a contact address, and a credit card number.

The store-side terminal 21 and the sales management server 22 may serve as a part of a so-called point of sale (POS) system constructed in the sales channel 20. In this case, the serial number DSN of the device 41 and the customer information CI input from the store-side terminal 21 are accumulated in the sales management server 22 through the POS system. If the store 24 is a shopping site on the Internet (virtual store), this site has a function substantially similar to that of the store-side terminal 21, and the serial number DSN of the device 41 determined to be purchased in the site by a user who accessed the site and the customer information CI input by the user in the site are transmitted to the sales management server 22 via the site.

The sales management server 22 includes, as its function, a customer information management section 22a that manages identification information (serial number DSN) of the purchased device 41 and the customer information CI in association (linked) with each other. The customer information management section 22a receives the serial number DSN and the customer information CI transmitted from the store-side terminal 21 as described above, and causes a predetermined memory section 22b to store the received serial number DSN and customer information CI in association with each other. Consequently, by using the purchase of the device 41 by the user as a trigger, the serial number DSN of the device 41 and the customer information CI of the user who purchased the device 41 are registered in the sales management server 22. The memory section 22b is constituted by a memory device such as a hard disk drive or a flash memory, for example. As described above, the customer information CI includes an address specified by a user. The address is delivery destination information indicating a delivery destination to which the sales channel 20 delivers a consumable to a user using the present service. Thus, the customer information management section 22a may also be a delivery destination management section that manages the identification information (serial number DSN) of the purchased device 41 and the delivery destination information indicating the delivery destination of the consumable in association with each other.

The sales management server 22 (customer information management section 22a) transmits the thus-received serial number DSN of the device 41 to the consumable management server 30 through the network NW. At this time, the sales management server 22 transmits unique identification information (channel identification information CID) for identifying the sales management server 22 or sales channel 20 to which the sales management server 22 belongs, to the consumable management server 30 together with the serial number DSN of the device 41. The channel identification information CID is identification information that is determined in advance and differs for each sales channel 20. Such channel identification information CID corresponds to supplier information indicating a supplier of the device 41.

The consumable management server 30 includes, as its function, an identification information management section 30a. The identification information management section 30a receives the serial number DSN and the channel identification information CID transmitted from the sales management server 22 as described above, and causes a predetermined memory section 30b to store the received serial number DSN and channel identification information CID in association with each other. Consequently, by using the purchase of the device 41 by the user as a trigger, the serial number DSN of the device 41 and the supplier information (channel identification information CID) indicating a supplier of the device 41 are registered in the consumable management server 30. The memory section 30b is constituted by a memory device such as a hard disk drive or a flash memory. From the viewpoint of personal information protection, the sales management server 22 does not transmit customer information CI to the consumable management server 30.

### Device Monitoring and Transmission Process of Consumable Information

FIG. 3 is a view for describing, for example, a relationship between the user terminal 40 and the consumable management server 30.

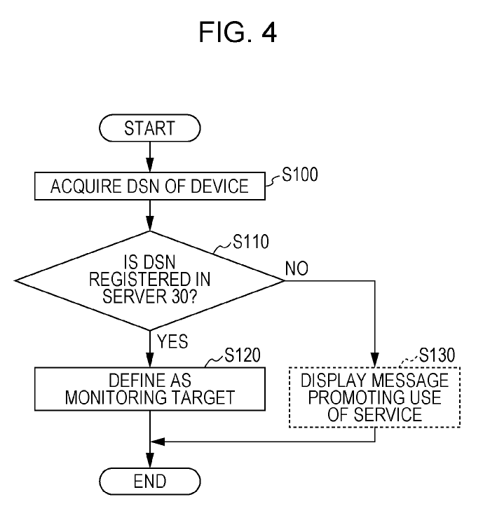

FIG. 4 is a flowchart describing a register confirmation process executed by the user terminal 40 on the premise of monitoring of the device 41. The register confirmation process is a type of a process performed by the user terminal 40 instructed from the application 42.

In step S100, the application 42 (user terminal 40 in which the application 42 is installed, the same hereinafter) acquires a serial number DSN of the device 41. For example, the application 42 transmits a request for acquiring the serial number DSN to a device 41 connected to the user terminal 40. The device 41 that has received the acquisition request transmits the serial number DSN of the device 41 to the user terminal 40. The application 42 receives and acquires the serial number DSN transmitted from the device 41 in response to the acquisition request.

In step S110, the application 42 determines whether the serial number DSN of the device 41 acquired in step S100 is registered in the consumable management server 30 or not. That is, the application 42 determines whether the device 41 having the serial number DSN is in the state of being capable of using the present service or not. For example, the application 42 transmits the serial number DSN acquired in step S100 to the consumable management server 30 through the network NW together with a registration confirmation request (registration confirmation request CR) of the serial number DSN. In the consumable management server 30 that has received the registration confirmation request CR, the identification information management section 30a determines whether the serial number DSN received together with the registration confirmation request CR is stored (registered) in the memory section 30b or not, and transmits, through the network NW, the determination result (determination result RJ) to the user terminal 40 that has transmitted the registration confirmation request CR. A process is caused to branch by the application 42 in accordance with the determination result RJ transmitted from the consumable management server 30 in response to the registration confirmation request CR.

That is, if the determination result RJ indicates that the serial number DSN transmitted together with the registration confirmation request CR is stored in the memory section 30b, the application 42 determines that the serial number DSN acquired in step S100 has been registered in the consumable management server 30 “(Yes” in step S110), and the process proceeds to step S120. In step S120, the application 42 defines the device 41 that has acquired the serial number DSN in step S100, as a monitoring target. On the other hand, if the determination result RJ indicates that the serial number DSN transmitted together with the registration confirmation request CR is not stored in the memory section 30b, the application 42 determines that the serial number DSN acquired in step S100 has not been registered in the consumable management server 30 (“No” in step S110).

If “No” in step S110, the application 42 does not define the device 41 whose serial number DSN was acquired in step S100 as the monitoring target, and finishes the flowchart. If “No” in step S110, the application 42 may display a massage encouraging application for use of the present service in a mode such as a popup window on a screen of the user terminal 40 (step S130).

The application 42 monitors the device 41 defined as a monitoring target, and acquires consumable information (consumable information IR) of a consumable from the device 41. In the case where the consumable is an ink cartridge as described above, the application 42 acquires, from the device 41, the amount of remaining ink for each ink cartridge mounted on the device 41. The amount of remaining ink of an ink cartridge is information with which the amount of ink remaining in the ink cartridge is directly or indirectly indicated or estimated. The printer (device 41) incorporates ink cartridges for a plurality of ink colors (e.g., black, cyan, magenta, yellow, etc.). Although not specifically described, each ink cartridge includes an IC chip, and this IC chip records a current ink remaining amount in the ink cartridge. Thus, the application 42 can acquire, as a type of consumable information IR, a current amount of remaining ink of each color recorded in the IC chip of each ink cartridge.

The application 42 transmits latest consumable information IR of the device 41 to the consumable management server 30 regularly or irregularly. For example, the application 42 transmits consumable information IR of the device 41 to the consumable management server once a day at a determined time. Alternatively, if the amount of remaining ink acquired from the device 41 is below a predetermined threshold, the application 42 may transmit consumable information IR including the amount of remaining ink to the consumable management server 30. The frequency of acquisition of the consumable information IR from the device 41 by the application 42 also varies. For example, the application 42 may acquire the consumable information IR every time the device 41 finishes printing based on a print job, of if the consumable information IR is transmitted to the consumable management server 30 at a predetermined timing, the application 42 may acquire the consumable information IR beforehand in consideration of the timing.

At the time when the application 42 transmits the consumable information IR of the device 41 to the consumable management server 30, the application 42 also transmits the serial number DSN of the device 41 from which the consumable information IR is acquired. The application 42 may also acquire information such as a serial number (cartridge serial number) of each ink cartridge, model number information of each ink cartridge, and the number of replacements of ink cartridges for each ink color in addition to the amount of remaining ink of each ink cartridge from the device 41, and transmit the consumable information IR including these pieces of information to the consumable management server 30. Each ink cartridge is provided with a unique serial number. The number of replacements of ink cartridges for each ink color is the number of replacements of ink cartridges that has been counted by the device for each ink color.

In the consumable management server 30, a consumable information acquisition section 30c acquires the consumable information IR and the serial number DSN of the device 41 transmitted from the application 42. Although FIGS. 1 and 3, for example, illustrate only one combination of the device 41 and the user terminal 40, there are, of course, a large number of such combinations depending on the number of devices 41 using the present service. Thus, the consumable information acquisition section 30c can be assumed to acquire consumable information IR of each device 41 identified based on the identification information (serial number DSN) through the network NW.

### Consumable Order Process Based on Consumable Information

FIG. 5 is a view for describing a relationship among the consumable management server 30, the sales management server 22, and the delivery-side terminal 23.

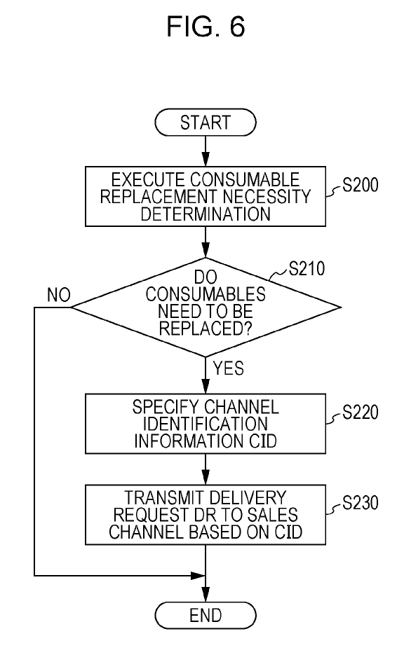

FIG. 6 is a flowchart describing a consumable order process performed by the order processing section 30d.

The order processing section 30d performs determination (consumable replacement necessity determination) whether a consumable is in the state of requiring replacement or not based on the consumable information IR acquired by the consumable information acquisition section 30c (step S200). Here, a consumable order process concerning a device 41 identified based on a serial number DSN will be described with reference to FIG. 6.

The order processing section 30d basically compares the amount of remaining ink for each ink cartridge included in the consumable information IR corresponding to the serial number DSN with a predetermined threshold (the threshold described above), and determine an ink cartridge in which the amount of remaining ink is below the threshold as a consumable to be replaced. In a case where there are one or more consumables to be replaced for one device 41, the order processing section 30d determines that replacement of consumables is necessary (“Yes” in step S210). If “Yes” is determined in step S210, the order processing section 30d proceeds to step S220, whereas if “No” is determined in step S210, the flowchart of FIG. 6 is finished.

Based on channel identification information CID associated with a serial number DSN of a device 41 for which it is determined that replacement of consumables is necessary, the order processing section 30d transmits a delivery request (delivery request DR) for a consumable to a supplier (sales channel 20) of the device 41 through the network NW (steps S220 and S230). That is, the order processing section 30d specifies the channel identification information CID associated with the serial number DSN of the device 41 for which replacement of consumables is necessary by referring a relationship between the serial number DSN and the channel identification information CID managed by the identification information management section 30a (stored in the memory section 30b) (step S220). Then, the order processing section 30d transmits a delivery request DR to a sales channel 20 (sales management server 22) indicated by the specified channel identification information CID (step S230).

The order processing section 30d transmits the delivery request DR including the serial number DSN of the device 41 for which replacement of consumables is necessary and consumable replacement information (e.g., model number information of an ink cartridge of black ink if the consumable to be replaced is an ink cartridge of black ink) indicating a consumable to be replaced. Accordingly, the order processing section 30d performs an automatic order of a consumable that needs to be replaced in the device 41.

In this embodiment, the order processing section 30d may further employ a configuration to avoid a duplicate order of consumables as described below. The duplicate order herein refers to an order in which a delivery request DR concerning a device 41 that needs consumable replacement is transmitted and then another delivery request DR is transmitted again before consumables are replaced.

In step S200 that is performed based on the consumable information IR acquired by the consumable information acquisition section 30c, the order processing section 30d determines whether replacement of consumables has been performed or not after transmission of the previous delivery request DR and whether the consumption degree of the current consumable exceeds a predetermined level or not. If replacement of consumables has been performed after transmission of the previous delivery request DR and the consumption degree of the current consumable exceeds the predetermined level, it is determined that replacement of consumables is necessary (“Yes” in step S210). The state in which the consumption degree of the current consumable exceeds the predetermined level refers to a state in which the amount of remaining ink of an ink cartridge is below the threshold in the foregoing example.

Determination on whether replacement of consumables for a device 41 has been performed or not after transmission of the previous delivery request DR may be performed by using, for example, one of the following methods a through c:

a. If a cartridge serial number included in the consumable information IR that was referred to in the consumable order process (FIG. 6) at the transmission of the previous delivery request DR is different from a cartridge serial number included in consumable information IR that is referred to in the current consumable order process (FIG. 6), it is determined that replacement of consumables has been performed after the previous delivery request DR. More specifically, if a cartridge serial number of black ink included in the consumable information IR that was referred to in the consumable order process (FIG. 6) at the transmission of the previous delivery request DR is different from a cartridge serial number of black ink included in the consumable information IR that is referred to in the current consumable order process (FIG. 6), replacement of ink cartridges of black ink as a result of transmission of the previous delivery request DR is identified. Thereafter, if the amount of remaining ink of an ink cartridge of black ink after the replacement performed in the foregoing manner (the amount of remaining ink of an ink cartridge of black ink included in the consumable information IR that is referred to in the current consumable order process (FIG. 6)) is less than the threshold, it is ensured that replacement of ink cartridges of black ink is necessary, “Yes” is determined in step S210.

b. If the number of replacements of ink cartridges of each ink color included in the consumable information IR that is referred to in the current consumable order process (FIG. 6) is larger than the number of replacements of ink cartridges of each ink color included in the consumable information IR that was referred to in the consumable order process (FIG. 6) at the transmission of the previous delivery request DR, it is determined that replacement of consumables was performed after the previous delivery request DR. More specifically, if the number of replacements of ink cartridges of black ink included in the consumable information IR that is referred to in the current consumable order process (FIG. 6) is larger, by one, than the number of replacements of ink cartridges of black ink included in the consumable information IR that was referred to in the consumable order process (FIG. 6) at the transmission of the previous delivery request DR, replacement of ink cartridges of black ink as a result of transmission of the previous delivery request DR is identified. Thereafter, if the amount of remaining ink of an ink cartridge of black ink after the replacement performed in the foregoing manner (the amount of remaining ink of an ink cartridge of black ink included in the consumable information IR that is referred to in the current consumable order process (FIG. 6)) is less than the threshold, it is ensured that replacement of ink cartridges of black ink is necessary, “Yes” is determined in step S210.

c. From the history of the amount of remaining ink, if the history of an abrupt increase of the amount of remaining ink is identified after transmission of the previous delivery request DR, it is determined that replacement of consumables was performed after transmission of the previous delivery request DR. The history of the amount of remaining ink is a history of change of the remaining ink amount of an ink cartridge recorded based on consumable information IR acquired by the consumable information acquisition section 30c for each device 41 (serial number DSN) and for each ink color, for example. This determination method c is effective in a case where none of the determination methods a and b can be performed. More specifically, in the history of the remaining ink amount of an ink cartridge of black ink, if an abrupt increase in the remaining ink amount after transmission of the previous delivery request DR (an increase to a predetermined amount close to the maximum amount of the ink cartridge) is observed, replacement of ink cartridges of black ink based on a result of transmission of the previous delivery request DR is determined. Thereafter, if the amount of remaining ink of an ink cartridge of black ink after the replacement performed in the foregoing manner (the amount of remaining ink of an ink cartridge of black ink included in the consumable information IR that is referred to in the current consumable order process (FIG. 6)) is less than the threshold, it is ensured that replacement of ink cartridges of black ink is necessary, “Yes” is determined in step S210.

Such a configuration can avoid a duplicate order of the same consumable.

Process after Reception of Delivery Request DR

In the sales management server 22, the delivery processing section 22c receives the delivery request DR transmitted from the consumable management server 30. Next, the delivery processing section 22c refers to a relationship between the serial number DSN of the device 41 included in the received delivery request DR and the serial number DSN and the customer information CI managed by the customer information management section 22a (stored in the memory section 22b) and, thereby, specifies an address (delivery destination information) corresponding to the serial number DSN included in the received delivery request DR. Thereafter, the delivery processing section 22c transmits the received delivery request DR to the delivery-side terminal 23 together with the specified delivery destination information. This process of transmitting the delivery request DR to the delivery-side terminal 23 together with the delivery destination information corresponds to a specific example of a delivery process of a consumable based on the delivery destination information.

By using reception of the delivery request DR and the delivery destination information by the delivery-side terminal 23 from the sales management server 22 as a trigger, the delivery center 25 delivers a consumable. That is, the delivery center 25 specifies a consumable to be delivered based on the consumable replacement information included in the delivery request DR, and delivers the specified consumable to an address indicated in the delivery destination information by using a predetermined logistics method. As a result, a consumable for replacement is delivered to a user of a device 41 requiring replacement of consumables.

As described above, in this embodiment, if the consumable management server 30 determines that a consumable of a device 41 identified based on a serial number DSN is in the state of requiring replacement based on the consumable information IR transmitted from the application 42 monitoring the device 41, the consumable management server 30 transmits a delivery request DR of a consumable to a supplier (sales channel 20) of the device 41 through the network NW based on supplier information (channel identification information CID) associated with the serial number DSN of the device 41. Accordingly, the user of the device 41 does not need to purchase consumables by him/herself every time consumables are in short or reduce in amount, and can easily obtain (purchase) a consumable for replacement. Since a consumable is delivered from a supplier (sales channel 20) from which the user purchased the device 41, profit of the supplier is assured. In addition, the use of the present service causes the consumable management server 30 to automatically transmit a delivery request DR to the sales channel 20 before a consumable is out of use (before the amount pf remaining ink of an ink cartridge becomes zero), and thus, a period in which the user cannot use the device 41 can be reduced.

Any payment method may be used for purchased consumables for the use of the present service. For example, when the sales management server 22 receives a delivery request DR from the consumable management server 30, the sales channel 20 settles a payment of purchase of a consumable corresponding to the delivery request DR by using a credit card number included in customer information CI registered in the sales management server 22.

### 2. Second Embodiment

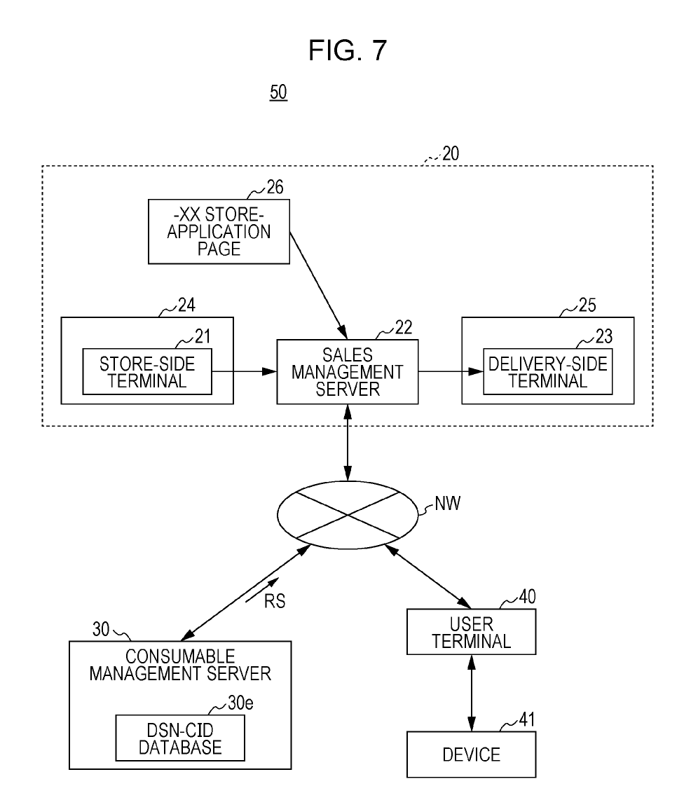

FIG. 7 is a simplified view of a system 50 according to a second embodiment. In the second embodiment, points of the system 50 different from those of the system 10 (first embodiment) will be described. At least a part of a configuration of the system 50 will be hereinafter referred to as a consumable management system.

FIG. 7 illustrates that the consumable management server 30 holds a DSN-CID database 30e (hereinafter referred to as a database 30e). Alternatively, the consumable management server 30 is in a state in which the database 30e is accessible. The database 30e is a database in which serial numbers DSN of all the possible devices 41 that can use the present service are associated with channel identification information CID. A manufacturer of a device 41, such as a printer manufacturer if the device 41 is a printer, for example, knows a correspondence between the serial number DSN of each device 41 and a sales channel 20 when shipping (selling) manufactured devices 41 to a plurality of sales channels 20. Thus, a database indicating a correspondence between the serial number DSN of each device 41 and the sales channel 20 (channel identification information CID) as a shipping destination at the time of such shipping is the database 30e.

FIG. 7 illustrates an example of a part of a website 26. The website 26 is a type of a website provided on the Internet by a sales management server 22, and is a site on which a user who purchased the device 41 applies for use of the present service. The user who purchased the device 41 in a store 24 in a sales channel 20 accesses the website 26 through the Internet at any timing such as after coming home, and inputs various pieces of information (serial number DSN of the purchased device 41 and customer information CI) on the website 26 to thereby apply for the use of the present service. The information input on the website 26 can be obtained by the sales management server 22 that provides the website 26.

In the first embodiment, a user applies for the use of the present service in the store 24 where the user purchased the device 41, and various pieces of information (serial number DSN of the device 41 and customer information CI) necessary for the application are transmitted from a store-side terminal 21 to the sales management server 22. Thus, in the first embodiment, it can be assumed that the sales channel 20 where the device 41 was purchased coincides with the sales channel 20 where the user who purchased the device 41 applied for the use of the present service. On the other hand, in the second embodiment, these sales channels 20 do not necessarily coincide with each other. As described above, there are a plurality of sales channels 20 of devices 41. In another case, a plurality of sales channels 20 might open sites, similar to the website 26, to accept application for the use of the present service by the user in near future.

Thus, for example, it is possible that a user who purchased a device 41 in a first sales channel 20 accesses a website operated by a second sales channel 20 different from the first sales channel 20 through the Internet to apply for the use of the present service. In such a case, according to the flow of the first embodiment, although the user purchased the device 41 in the first sales channel 20, subsequent delivery of consumables is made by the second sales channel 20, and profit of the first sales channel 20 cannot be assured.

To solve such a problem, in the second embodiment, when the consumable management server 30 receives a serial number DSN of a device 41 and channel identification information CID transmitted from a sales management server 22 of a sales channel 20 (see FIG. 2), the consumable management server 30 determines whether the serial number DSN and the channel identification information CID are to be registered in the consumable management server 30 or not with reference to the database 30e. Specifically, when the identification information management section 30a receives the serial number DSN of the device 41 and the channel identification information CID from the sales management server 22, the identification information management section 30a determines whether a correspondence between the serial number DSN and the channel identification information CID is recorded in the database 30e or not.

If the serial number DSN and the channel identification information CID received from the sales management server 22 are recorded in association with each other in the database 30e, the identification information management section 30a causes a memory section 30b to store the serial number DSN and the channel identification information CID in association with each other. Then, the identification information management section 30a transmits a registration approval notification as a response RS to the sales management server 22 that has transmitted the serial number DSN and the channel identification information CID. This is because if a combination of the serial number DSN and the channel identification information CID received from the sales management server 22 is recorded in the database 30e, it is determined that a user applied for the use of the present service to a supplier of the device 41. The sales management server 22 that has received the registration approval notification as the response RS, recognizes that information transmitted to the consumable management server 30 by itself using the application for the use of the present service by the user as a trigger is registered in the consumable management server 30.

On the other hand, if the serial number DSN and the channel identification information CID received from the sales management server 22 are not recorded in the database 30e in association with each other, the identification information management section 30a does not cause the memory section 30b to store the serial number DSN and the channel identification information CID in association with each other. Then, the identification information management section 30a transmits a registration disapproval notification as a response RS to the sales management server 22 that has transmitted the serial number DSN and the channel identification information CID. This is because if a combination of the serial number DSN and the channel identification information CID received from the sales management server 22 is not recorded in the database 30e, it is determined that a user applied for the use of the present service to a sales channel 20 different from the supplier of the device 41. The sales management server 22 that has received the registration disapproval notification as the response RS, recognizes that information transmitted to the consumable management server 30 by itself using the application for the use of the present service by the user as a trigger is not registered in the consumable management server 30.

In the sales management server 22 that has received the registration disapproval notification, the customer information management section 22a deletes information (combination of the serial number DSN and the customer information CI) corresponding to the registration disapproval notification, from the memory section 22b. The sales management server 22 may notify a user who applied for the use of the present service of the reception of the registration disapproval notification by using a contact method such as an electronic mail. In the second embodiment described above, if the sales channel 20 where the user purchased the device 41 is different from the sales channel 20 where the user applied for the use of the present service, registration of information in the consumable management server 30 is disapproved, and the user cannot use the present service. Accordingly, profit of the sales channel 20 where the user purchased the device 41 is more firmly assured. In other words, sales efforts of each sales channel 20 for devices 41 are more firmly connected to sales of consumables of the sales channel 20 itself.

### 3. Other Embodiments

The present invention may further employ the following embodiments. Combinations of a plurality of embodiments also constitute the range of disclosure of the present application.

For example, if one of a plurality of consumables mounted on a device 41 is in the state of requiring replacement, the order processing section 30d may transmit, to a supplier of the device 41, a delivery request DR for the consumable in the state of requiring replacement and a consumable except the consumable in the state of requiring replacement.

Suppose the order processing section 30d determines that there is a consumable to be replaced, that is, the device 41 needs replacement of consumables (“Yes” in step S210) because the amount of remaining ink in an ink cartridge of a first ink color as a result of execution of the consumable replacement necessity determination (step S200 in FIG. 6). At this time, suppose consumable information IR of device 41 indicates that there is an ink cartridge of a second ink color whose remaining ink amount is greater than or equal to the threshold (hereinafter referred to as a first threshold) but is less than a predetermined second threshold that is larger than the first threshold. In this case, in the order processing section 30d, consumable replacement information included in a delivery request DR to be transmitted in step S230 includes not only information indicating the ink cartridge of the first ink color (model number information) but also information indicating the ink cartridge of the second ink color (model number information).

This configuration enables transmission of the delivery request DR for not only a consumable requiring replacement (e.g., the ink cartridge of the first ink color) but also another consumable that does not currently require replacement but will require replacement in near future (e.g., the ink cartridge of the second ink color). As a result, in accordance with the delivery request DR, the sales channel 20 (delivery center 25 including the delivery-side terminal 23) delivers the ink cartridge of the first ink color and the ink cartridge of the second ink color at the same time to a user of the device 41. Accordingly, the load of delivering consumables in the sales channel 20 can be reduced.

Although the foregoing description has been made on the premise that the user terminal 40 and the device 41 are separate products, the device 41 may function as the user terminal 40. That is, suppose the application 42 (or software implementing a function similar to that of the application 42) is installed in the device 41. Then, the device 41 may communicate with, for example, the consumable management server 30 through the network NW, and execute, by using its own resource, processes that are performed by the user terminal 40 in accordance with the application 42 in the foregoing description.

Consumables of the device 41 assumed in this embodiment are, of course, not limited to ink cartridges. For example, consumables include a wide range thereof, such as ink to be supplied to an ink tank provided in a printer, a toner cartridge to be used by a laser printer, a waste ink/toner box that temporarily stores waste ink or toner generated in a printer, and a lamp to be replaced for a projector.

What is claimed is:

1. A consumable management server connectable to a network, the consumable management server comprising:
a management section that manages identification information of a device using a consumable and supplier information indicating a supplier of the device in association with each other;
a consumable information acquisition section that acquires consumable information on the consumable of the device through the network; and
a delivery request processing section that transmits a delivery request for the consumable to the supplier through the network based on the supplier information associated with the identification information of the device in a case where the consumable is determined to be in a state of requiring replacement based on the consumable information.

2. The consumable management server according to claim 1, wherein
the delivery request processing section determines, based on the consumable information, whether replacement of the consumable is performed or not after transmission of a previous delivery request and whether a consumption degree of a current consumable exceeds a predetermined level or not and if replacement of the consumable is performed after transmission of the previous delivery request and the consumption degree of the current consumable exceeds the predetermined level, the delivery request processing section determines that the consumable is in the state of requiring replacement.

3. The consumable management server according to claim 1, wherein
if one of a plurality of consumables mounted on the device is in a state of requiring replacement, the delivery request processing section transmits, to the supplier, the delivery request for the consumable in the state of requiring replacement and a consumable except the consumable in the state of requiring replacement.

4. A consumable management system comprising:
a device using a consumable; and
a consumable management server including
a management section that manages identification information of the device and supplier information indicating a supplier of the device in association with each other, and
a delivery request processing section that acquires consumable information on the consumable of the device through a network and, in a case where the consumable is determined to be in a state of requiring replacement based on the consumable information, transmits a delivery request for the consumable to the supplier through the network based on the supplier information associated with the identification information of the device.

5. The consumable management system according to claim 4, further comprising
a supplier server that belongs to the supplier, wherein
the delivery request processing section transmits the delivery request together with the identification information of the device for which the consumable is in the state of requiring replacement, to the supplier server through the network, and
the supplier server includes
a delivery destination management section that manages identification information of a purchased device and delivery destination information indicating a delivery destination of the consumable in association with each other and
a delivery processing section that executes a delivery process of the consumable based on the delivery destination information associated with the identification information received from the consumable management server together with the delivery request in the delivery destination management section.
